(19) United States
(12) Patent Application Publication
(10) Pub. No.: US 2010/0283185 A1
(43) Pub. Date: Nov. 11, 2010

(54) STAMPER MANUFACTURING METHOD, STAMPER, AND MOLDING MANUFACTURING METHOD

(75) Inventor: Ikuo Koumaru, Chiba (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/763,290

(22) Filed: Apr. 20, 2010

(30) Foreign Application Priority Data
May 8, 2009 (JP) 2009-113284

(51) Int. Cl. B29C 59/02; B29C 33/42

(52) U.S. Cl. 264/320; 264/219; 425/112

(57) ABSTRACT

A method of manufacturing a stamper includes setting a straight plate member to a die having a cavity, the plate member having a formation surface on which a predetermined pattern structure is formed, and feeding a continuous body into the cavity and pressurizing the plate member with the continuous body, to deform an entire shape of the formation surface of the plate member set to the die into a shape corresponding to the cavity.

### BACKGROUND OF THE INVENTION

1. Field of the Invention

The present invention relates to a stamper used as a mold in manufacturing a molding, a stamper manufacturing method, and a molding manufacturing method.

2. Description of the Related Art

In the past, there has been proposed an optical device such as a lens including an antireflective structure on a surface thereof. In an antireflective structure, conical, convex-concave shaped bodies are arranged in array at intervals equal to or lower than a wavelength of incident light (at submicron intervals in a case of visible light, for example) (see, for example, Japanese Patent Application Laid-open No. 2006-130841 (hereinafter, referred to as Patent Document 1)).

In a method of manufacturing an antireflective structure shown in FIG. 3 of Patent Document 1, an acicular crystal 33 of Ni—Cu—P is formed on a concave surface of a silica glass substrate by a sputtering and an electroless plating. The Ni—Cu—P acicular crystal is used as a mask, and a dry etching process is performed until the acicular crystal is eliminated, thereby forming a convex lens mold 34 as shown in FIG. 3D of Patent Document 1. Further, as shown in FIG. 4 of Patent Document 1, a press process is performed on a mold material 42 by using the convex lens mold 34, thereby forming an optical device having an antireflective structure corresponding to the shape of the acicular crystal 33.

In the optical device disclosed in Patent Document 1, the acicular crystal is pointed only in one direction due to constraints of principles of an etching process. Therefore, the reflection of light that has entered the optical device mainly in an optical axis direction can be reduced, but the reflection of incident light having an angle with respect to the optical axis cannot be reduced.

On the other hand, Japanese Patent Application Laid-open No. 2008-37089 (hereinafter, referred to as Patent Document 2) discloses an optical device on a convex surface of which a convex-concave structure for antireflection is formed (FIG. 7A), and an optical device on a concave surface of which a convex-concave structure for antireflection is formed in the same way (FIG. 7B). In each of the optical devices disclosed in Patent Document 2, the convex-concave structure is formed in a normal direction with respect to the convex surface (concave surface). By using molds having convex-concave structures corresponding to the convex-concave structures, the optical devices are formed (see, for example, paragraphs 0028, 0029, 0047, 0048, and 0073 of Patent Document 2).

### SUMMARY OF THE INVENTION

However, Patent Document 2 discloses that the molds having the convex-concave structures are formed by sputtering and etching processes. It is not realistic to perform an exposure and an etching so that the convex-concave structures are each formed on a curved surface of the mold for manufacturing the optical device shown in FIG. 7 of Patent Document 2, for example. If the convex-concave structures are tried to be realized, it is necessary to form protrusions one by one by hourly changing directions of the exposure and the etching, which requires a great deal of time. Therefore, the above process is not suitable for mass production.

In view of the above-mentioned circumstances, it is desirable to provide a stamper, a stamper manufacturing method, and a molding manufacturing method capable of realizing a product in which a predetermined pattern structure is formed on a nonplanar surface and improving the productivity of the product.

According to an embodiment of the present invention, there is provided a method of manufacturing a stamper. The method includes setting a straight plate member to a die, the plate member having a formation surface on which a predetermined pattern structure is formed and an opposite surface thereof, so as to cause the opposite surface to face a cavity of the die.

The method includes feeding a continuous body into the cavity from a side of the formation surface of the plate member and pressurizing the plate member with the continuous body, to deform an entire shape of the formation surface of the plate member set to the die into a shape corresponding to the cavity.

That is, the formation surface of the plate member, on which the pattern structure is formed, is formed into a shape corresponding to the cavity with the continuous body being as a core. With this structure, for example in a case where the inner surface of the cavity has a nonplanar shape, the entire shape of the formation surface is formed into a curved surface shape, with the result that a stamper having a predetermined pattern structure formed on the nonplanar surface can be manufactured. As a result, by forming a molding target object by using the stamper, it is possible to manufacture a product (molding) on a surface of which the pattern structure corresponding to the pattern structure of the stamper formed. Therefore, it is possible to manufacture products in a large quantity at a low cost and in a short time, which can improve the productivity.

The nonplanar surface includes a curved surface and a surface in combination with two or more planes. The curved surface includes a spherical surface, a non-spherical surface, and the like.

The continuous body may be a resin.

The method of manufacturing a stamper may further include modifying a shape of an inner surface of the cavity of the die after the plate member is pressurized. In this case, the stamper formed by the pressurization is set to the die having the modified shape of the inner surface of the cavity. In addition, in order that the entire shape of the formation surface of the stamper is deformed into a shape corresponding to the modified cavity of the die, the stamper is pressurized by the continuous body fed into the cavity.

That is, the molding target object is formed by using the stamper formed first. If it is necessary to modify the shape of the molding, the shape of the stamper formed first is modified. In this case, the inner surface of the cavity is modified, and the stamper is formed with the die again, thereby making it possible to modify the shape of the stamper. As a result, the manufacturing cost of the stamper can be cut.

The stamper may be a stamper used for forming an optical device having an optical pattern structure corresponding to the pattern structure. For example, as the optical pattern structure, a structure that exerts an antireflection function, such as a convex-concave structure, may be used.

The die may be a direct gate type. That is, a die in which a sprue is directly connected to a gate without a runner may be used. With this structure, it is possible to improve a uniformity of the pressure that is applied to the plate member in the cavity by the continuous body as the core.

According to another embodiment of the present invention, there is provided a stamper manufactured by the manufacturing method described above.

According to another embodiment of the present invention, there is provided a method of manufacturing a molding. The method includes preparing a stamper formed by setting a straight plate member to a die, the plate member having a formation surface on which a predetermined pattern structure is formed and an opposite surface thereof, so as to cause the opposite surface to face a cavity of the die and pressurizing the plate member with a continuous body fed into the cavity of the die from a side of the opposite surface of the plate member, to deform an entire shape of the formation surface of the plate member into a shape corresponding to the cavity of the die.

The method includes forming a mold target object having a structure corresponding to the pattern structure by using the stamper.

As described above, according to the embodiments of the present invention, it is possible to realize the product in which the predetermined pattern structure is formed on the non-planar surface and improve the productivity of the product.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 are diagrams sequentially showing steps of manufacturing a master for forming a stamper in a manufacturing process of the stamper according to an embodiment of the present invention;

FIG. 2 is a picture of a surface of a resist mask shown in FIG. 1C which is exposed by using a PTM technique and then developed, the picture being taken with an electron microscope;

FIG. 3 is a picture of a surface of a UV resin obtained by transferring the master of FIG. 1D after a moth-eye structure is formed, the picture being taken with an electron microscope;

FIG. 4 is a cross-sectional view schematically showing a stamper die in a state where a plate member obtained as shown in FIG. 1F is set in the stamper die for forming the stamper;

FIG. 5 is a cross-sectional view showing a state where a resin is fed into a cavity of the stamper die, and the stamper is subjected to a drawing process;

FIG. 6 is a cross-sectional view schematically showing the stamper manufactured;

FIG. 7 is a table showing design values and draft angles of fifteen stampers manufactured in a test;

FIG. 8 is a schematic diagram showing the stamper corresponding to the table of FIG. 7;

FIG. 9 is a graph showing a course of a waveform of a pressure of a resin in the cavity of the stamper die at a time when a stamper of, e.g., No. 10 in the table of FIG. 7 is formed;

FIG. 10 is a picture of a resin body that is used for forming the stamper of No. 10 in FIG. 7 and fed into the stamper die;

FIG. 11 is a picture of the stamper of No. 10 in FIG. 7;

FIG. 12 is a cross-sectional diagram showing a lens mold for forming a convex lens as a product (molding) by using the stamper manufactured by the manufacturing method shown in FIGS. 4 and 5;

FIG. 13 is a picture of the stamper attached to the reception piece, which is viewed from the side of the core plate;

FIG. 14 is a picture of a convex lens product formed with the lens mold;

FIG. 15 are cross-sectional views sequentially showing a method of modifying the shape of the stamper;

FIG. 16 is a cross-sectional view schematically showing a stamper die for manufacturing a stamper used for forming a concave lens as a molding, with the straight plate member as a mold target being set;

FIG. 17 is a cross-sectional view showing a stamper die in a state where the resin is fed into a cavity of the stamper die, and the plate member is subjected to the drawing process; and

FIG. 18 is a cross-sectional diagram schematically showing the stamper manufactured.

### DESCRIPTION OF PREFERRED EMBODIMENTS

Hereinafter, an embodiment of the present invention will be described with reference to the drawings.

(Stamper Manufacturing Method 1)

In the following embodiment, a description will be given on a manufacturing method of a stamper for manufacturing an optical device as a product (molding). As an example of an optical device, typically, a lens having a moth-eye structure as a minute convex-concave structure as a predetermined pattern structure is given.

(Manufacturing Method of Master)

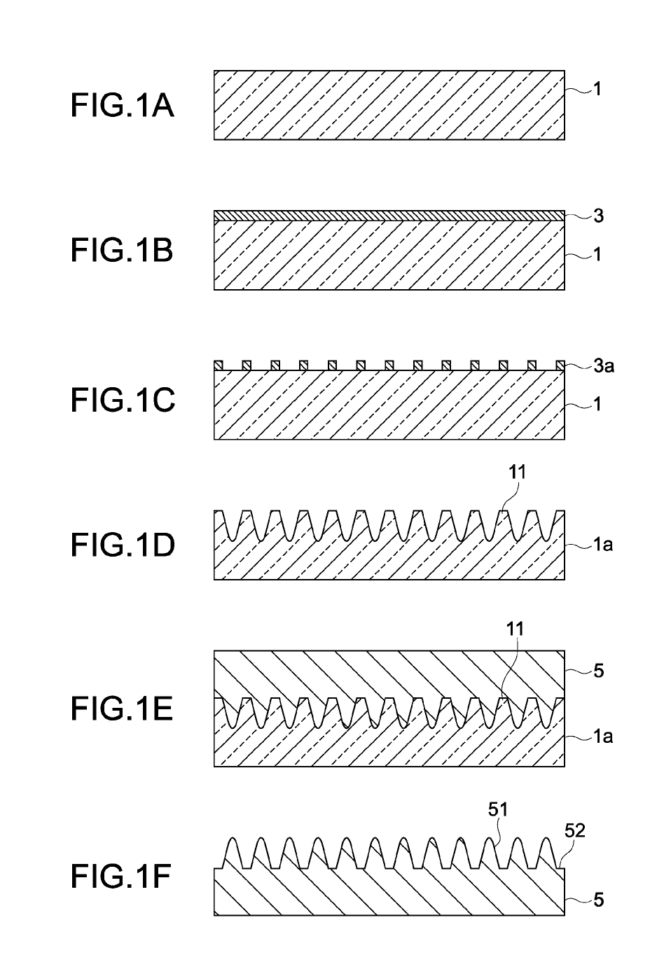

FIG. 1 are diagrams sequentially showing a process (FIGS. 1A to 1D) of manufacturing a master for forming a stamper in a manufacturing process of a stamper according to an embodiment of the present invention.

As shown in FIG. 1A, a substrate 1 made of quartz glass or the like is prepared, and a resist film 3 is formed on the substrate 1 as shown in FIG. 1B. Then, as shown in FIG. 1C, a photolithography technique such as the exposure and development is used, thereby forming in the resist film 3 a predetermined pattern. For example, a resist mask 3a having a large number of holes is formed. As shown in FIG. 1D, a master 1a having a moth-eye pattern structure 11 is formed by the etching.

(Manufacturing Method of Stamper for Convex Lens)

Further, as shown in FIG. 1E, the pattern of the moth-eye structure 11 of the master 1a is transferred to a metal material 5 by electroforming, for example. After that, the metal material 5 is stripped from the master 1a. As a result, as shown in FIG. 1F, the metal material 5 is formed into the straight plate member 5 having a moth-eye structure formation surface 52 on the surface of which the moth-eye structure 51 is formed.

In the process shown in FIG. 1E, the electroforming is given as an example, but an electroless plating such as a chemical plating or a vapor deposition may instead be used.

In the exposure process of FIG. 1C, typically, a PTM (phase transition mastering) technique can be applied. The PTM technique is a technique used mainly for manufacturing a master of a BD (Blu-ray disc).

In the PTM technique, an optical pickup of an optical disc drive is used as an exposure system, for example. Specifically, for example, a quartz glass substrate is rotated, and a laser light source of the optical pickup emits laser light. In accordance with the modulation of the intensity of light, a resist on the quartz glass substrate rotated is subjected to a selective exposure, thereby forming a predetermined latent image pattern on the resist. By using the PTM technique, the latent pattern can be formed in a short time.

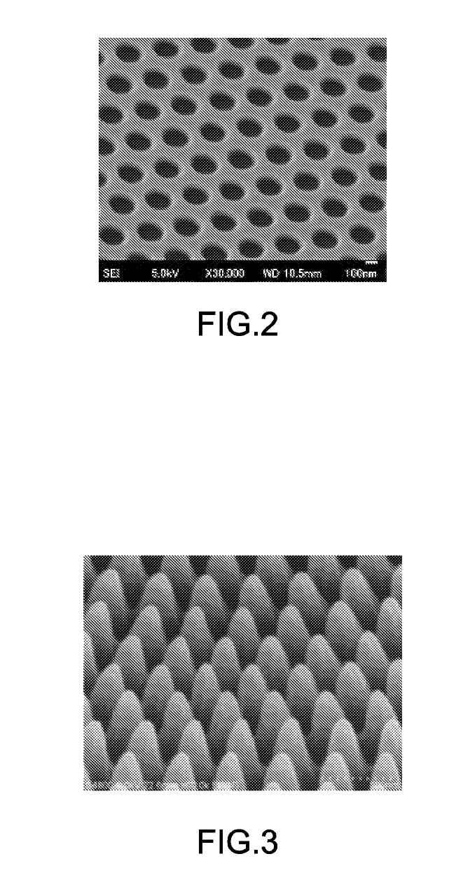

FIG. 2 is a picture of a surface of the resist mask 3a shown in FIG. 1C which is exposed by using the PTM technique and then developed. The picture is taken with an electron microscope. FIG. 3 is a picture of a surface of a UV resin obtained by transferring the master 1a of FIG. 1D after the moth-eye structure 11 is formed. The picture is taken with an electron microscope. The moth-eye structure in the picture has a large number of cone-shaped protrusions, for example. Intervals of the protrusions are set to about 280 nm, and heights thereof are set to 320 nm. In this case, an inorganic resist is used as a material of the resist, and an RIE (reactive ion etching) is used for the etching process.

In the electroforming used in the process of FIG. 1E, Ni or a Ni alloy (for example, NiCo, NiP, or NiB) is used as the metal material. The material of the plate member 5 is not limited to those materials.

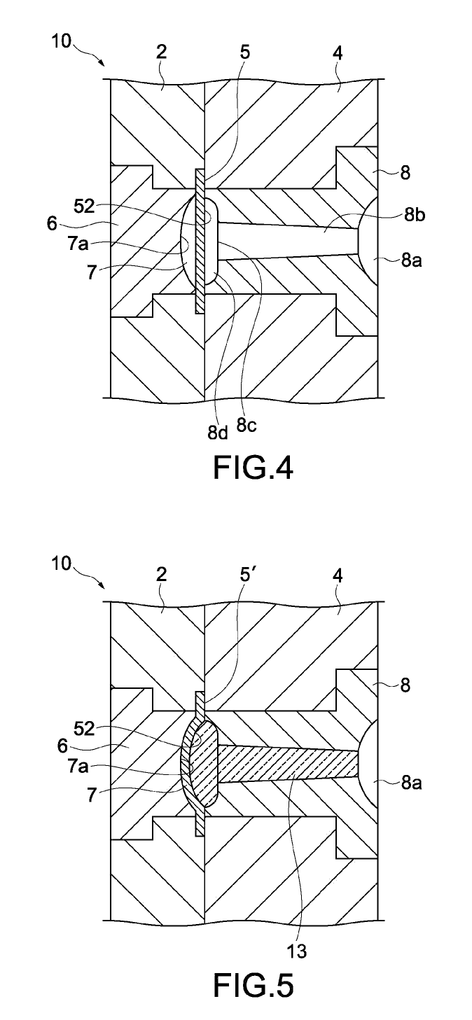

FIG. 4 is a cross-sectional view schematically showing a stamper die in a state where the plate member 5 obtained as shown in FIG. 1F is set in the stamper die for forming the stamper.

A stamper die 10 includes a movable plate 2 and a fixed plate 4. The movable plate 2 is equipped with a reception piece 6, and the fixed plate 4 is equipped with a sprue bush 8. The reception piece 6 is detachably attached to the movable plate 2 with a screw or another mounting fixture. The sprue bush 8 is also detachably attached to the fixed plate 4 with a screw or another mounting fixture. The plate member 5 is provided to the reception piece 6 so that the plate member is sandwiched between the reception piece 6 and the sprue bush 8, thereby setting the plate member 5 to the stamper die 10.

On the side of the sprue bush 8 of the reception piece 6, a cavity 7 for forming the plate member 5 into a desired shape is formed. The plate member 5 is disposed to face the cavity 7. The sprue bush 8 has a feed port 8a, a sprue 8b, a gate 8c, and a diffusion area 8d. From the feed port 8a, for example, a resin as a continuous body is fed as described later. The sprue 8b is communicated with the feed port 8a. The gate 8c is formed at an end portion of the sprue 8b. The diffusion area 8d diffuses the fed resin. The diffusion area 8d is larger than the diameter of a flow path of the sprue 8b. The plate member 5 is set so as to cause the formation surface 52 (see, FIG. 1F) for the moth-eye structure 51 to face the diffusion area 8d and to cause a surface opposite to the formation surface 52 to face the gate 8c. In this embodiment, an inner surface 7a of the cavity 7 of the reception piece 6 is formed into a spherical shape.

In this embodiment, as the stamper die 10, a direct-gate type is used. That is, a runner is not provided, and the sprue 8b is directly connected to the gate 8c, with the result that it is possible to improve the uniformity of a pressure that is applied to the plate member 5 in the cavity 7 by the resin as a core.

The diffusion area 8d of the sprue bush 8 is provided to be opposed to the cavity 7. The diffusion area 8d is an area used for pressurizing the plate member 5 by the resin fed therein. In the diffusion area 8d, the pressure applied by the resin is uniformly given to the entire area of the plate member 5 that is required to be deformed. Further, in the stamper die 10, the center axis of the cavity 7, the center axis of the diffusion area 8d, and the center of the gate 8c are substantially coincided with one another. As a result, the uniformity of the pressure applied to the plate member 5 by the resin discharged from the gate 8c is increased.

It is to be noted that the diffusion area 8d may not be provided. In this case, the diameter of an opening of the gate 8c can be designed to be an appropriate size so that the pressure of the resin is uniformly given to the plate member 5.

As shown in FIG. 5, a resin 13 is fed through the sprue 8b and gate 8c so as to press the formation surface 52 of the plate member, and fed into the cavity 7 of the stamper die 10. The entire shape of the formation surface 52 of the moth-eye structure 51 of the plate member 5 is deformed into a shape in accordance with the inner surface 7a of the cavity 7 by the pressure of the resin 13. In other words, a drawing process is performed on the plate member 5 by the pressure of the resin 13.

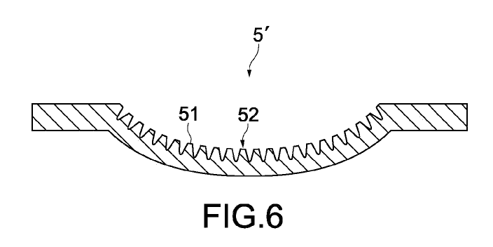

FIG. 6 is a cross-sectional view schematically showing a stamper 5′ formed as described above. In FIG. 6, the size of the moth-eye structure 51 is enlarged for ease of explanation. As shown in the figure, the stamper 5′ whose entire shape is a concave shape and which has the moth-eye structure 51 on the formation surface 52 as the concave surface is formed. In the moth-eye structure 51, each protrusion is directed in a direction normal to the concave surface.

In a state shown in FIG. 5, the movable plate 2 is removed from the fixed plate 4, thereby stripping the resin 13 from the stamper 5′ (stripping process). The resin 13 stripped off may be discarded or reused.

As described above, the formation surface 52 of the plate member 5, on which the moth-eye structure is formed, is formed into the spherical surface corresponding to the shape of the cavity 7 of the stamper die 10 with the resin 13 that is the continuous body used as the core. Because the entire shape of the formation surface 52 is formed into the spherical shape, the stamper 5′ having the moth-eye structure formed on the spherical surface can be manufactured. As a result, by forming an optical device by using the stamper 5′, it is possible to manufacture a lens product having a surface of a moth-eye structure corresponding to the moth-eye structure 51 of the stamper 5′. Thus, it is possible to manufacture products in large quantity at a low cost in a short time, with the result that the productivity can be increased.

In particular, by the manufacturing method of this embodiment, all the protrusions of the moth-eye structure 51 are substantially directed in a direction normal to the sphere of the formation surface 52. Thus, it is possible to increase a range of an incident angle of incident light, in which an antireflection effect can be exerted. As a result, in a case where a convex lens formed by the stamper 5′ is mounted on a camera or the like, it is possible to further reduce a flare or a ghost at the time of shooting by the camera as compared to a product in related art.

Hereinafter, a description will be given on a result of a manufacturing test of the stamper 5′ conducted by the inventor of the present invention.

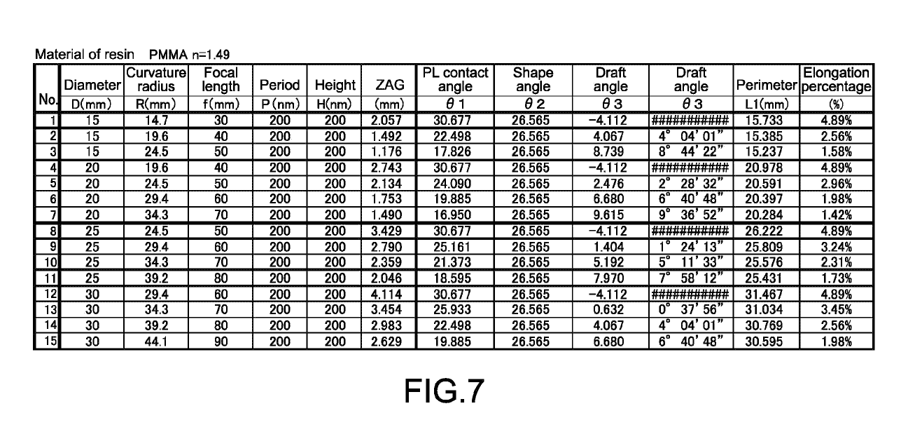

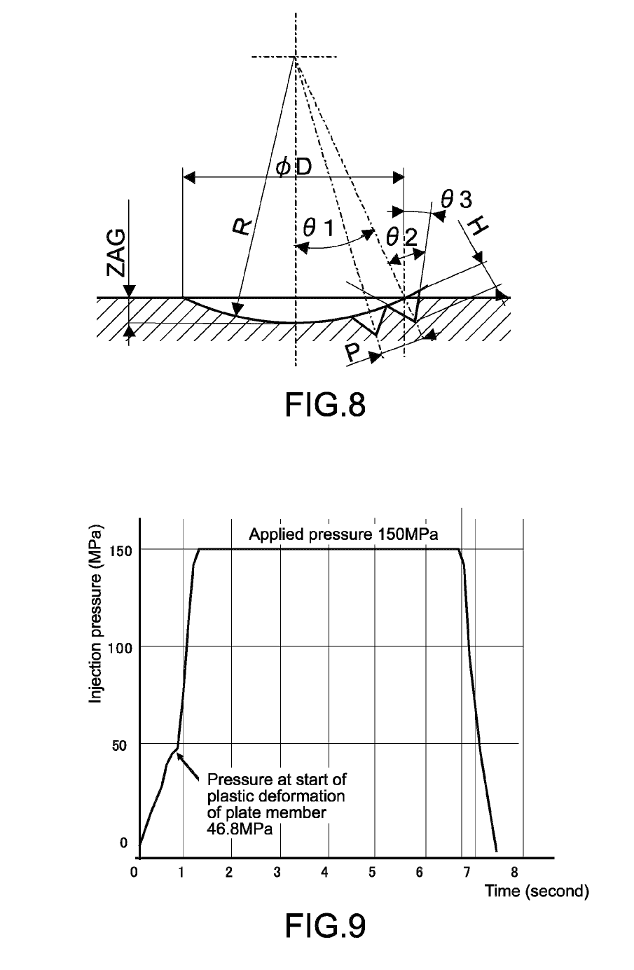

FIG. 7 is a table showing a design value and a draft angle for each of fifteen stampers 5′ manufactured in the test. The resin 13 used as the continuous body is PMMA (polymethylmethacrylate) in the test. In addition, the material of the plate member 5 that is to be the stamper 5′ is Ni, and the plate member 5 has a thickness of 0.5 mm. FIG. 8 is a schematic diagram showing the stamper 5′ corresponding to the table of FIG. 7. It is to be noted that FIG. 8 shows only one protrusion of the moth-eye structure.

FIG. 9 is a graph showing a course of a waveform of a pressure (injection pressure) of the resin 13 in the cavity 7 of the stamper die 10 at a time when the stamper 5′ of, e.g., No. 10 in the table of FIG. 7 is formed. As shown in FIG. 9, the pressure waveform shows that a climb gradient becomes temporarily small at 46.8 MPa, which means that the plate member 5 starts plastic deformation. Further, to make a spring-back of the plate member 5 small, the pressure is maintained to be 150 MPa for about 6 seconds.

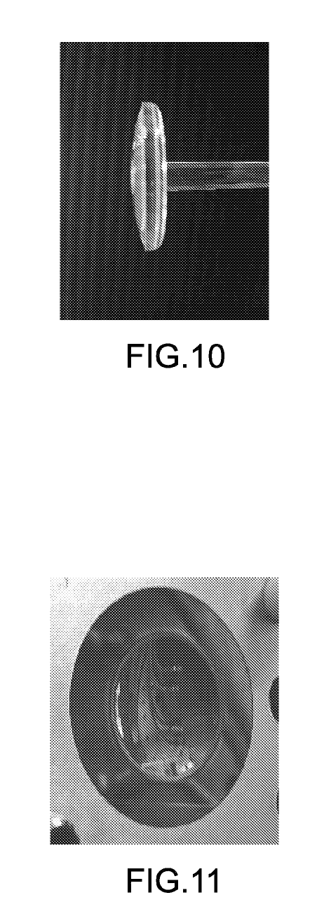

FIG. 10 is a picture of the resin body (PMMA material as described above) that is used for forming the stamper 5′ of No. 10 and fed into the stamper die 10. The resin body may be discarded or reused as described above. FIG. 11 is a picture of the stamper 5′ of No. 10.

In FIGS. 7 and 8, θ3 represents the draft angle. In FIG. 7, the draft angles θ3 of the stampers 5′ other than Nos. 1, 4, 8, and 12 are positive values, causing no problem in drawing out the resin 13 from each of the stampers 5′. On the other hand, the draft angles θ3 of the stampers 5′ of No. 1, 4, 8, and 12 are negative values. But, for the following reason, the resin 13 can be drawn out from each of the stampers 5′.

In the stripping process, the stamper 5′ receives a force in a direction in which the resin 13 is distanced from the stamper 5′. Because the stamper 5′ is thin, elastic deformation of the stamper 5′ occurs, and the stamper 5′ follows the movement of the resin 13. That is, even if each of the protrusions is directed in the normal direction as shown in FIG. 6, the elastic deformation of the stamper 5′ prevents the protrusions of the moth-eye structure 51 from being damaged, and the resin 13 can be stripped. In this case, as the plate member 5, a material having a thickness of, for example, 1 mm or less or in a range of 0.1 to 0.5 mm may be used in accordance with the material and the size.

(Manufacturing Method of Convex Lens)

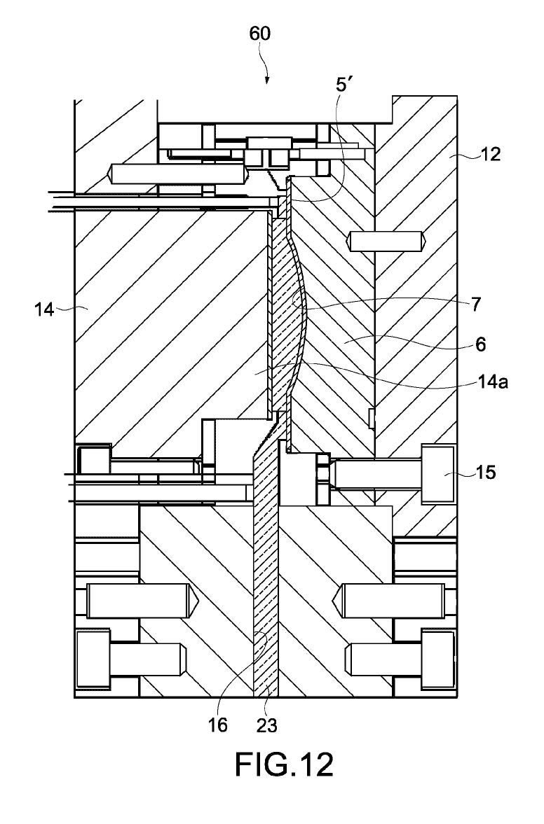

The stamper 5′ manufactured as described above is prepared and set to a lens mold 60 shown in FIG. 12. In the lens mold 60, the reception piece 6 used for the stamper die 10 shown in FIGS. 4 and 5 can be used as it is. For example, the lens mold 60 is provided with a reception piece plate 12 and a core plate 14 having a core 14a. On the reception piece plate 12, the reception piece 6 can be mounted. The reception piece 6 is mounted on the reception piece plate 12 with a mounting fixture such as a screw 15. As described above with reference to FIGS. 4 and 5, the stamper 5′ that is formed by using the reception piece 6 as a die is attached to the reception piece 6. The moth-eye structure is formed on a concave surface portion of the stamper 5′, although not shown in FIG. 12. The inside of the concave surface portion corresponds to the cavity 7. A resin material 23 is fed into the cavity 7 through a runner 16, thereby forming a convex lens.

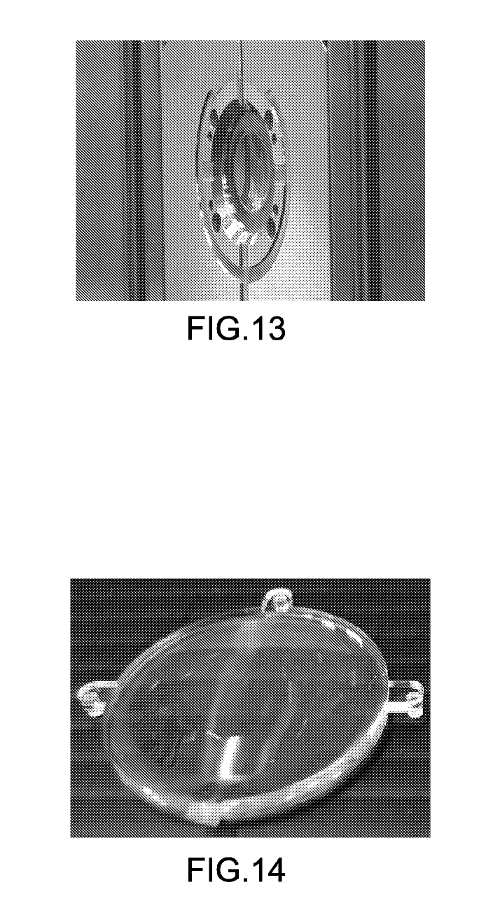

FIG. 13 is a picture of the stamper 5′ attached to the reception piece 6, which is viewed from the side of the core plate 14. FIG. 14 is a picture of a convex lens product formed with the lens mold 60.

(Method of Modifying Shape of Stamper)

Next, a description will be given on an example of modifying the shape of the stamper 5′. The shape of the lens often requires to be partly modified in processes of designing and manufacturing the lens.

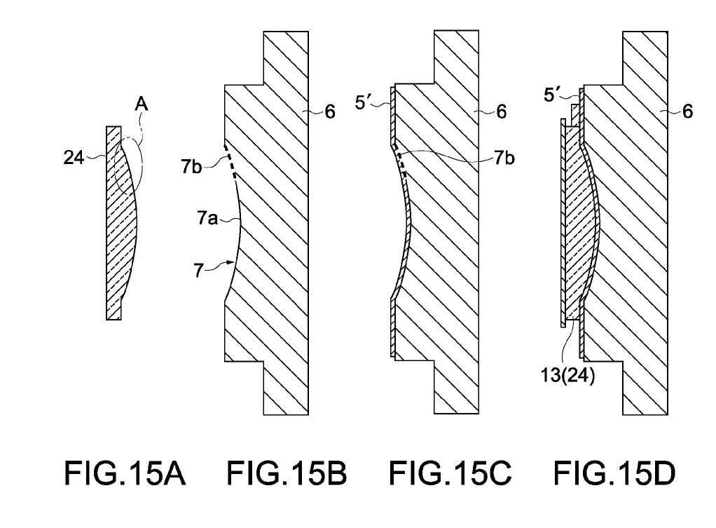

For example, a description will be given on a case where a part of a convex lens 24 formed as a molding, specifically, for example, a part A surrounded by the dash-dotted line in the figure is thickened, thereby modifying a curvature of the convex lens 24 as shown in FIG. 15A. As shown in FIG. 15B, a part 7b of the inner surface 7a of the cavity 7 of the reception piece 6 used for forming the stamper 5′ is shaved and modified. The depth of the shaving is a micrometer order, for example.

As shown in FIG. 15C, to (the reception piece 6 having) the modified cavity 7, the stamper 5′ is set, and the reception piece 6 is set again to the stamper die 10 shown in FIGS. 4 and 5. Further, by the applied pressure of the resin 13 as the continuous body that is fed into the cavity 7, the stamper 5′ is formed again. At this time, the shape of the stamper 5′ is modified in accordance with the shape of the inner surface 7a of the modified cavity 7.

According to this embodiment, there is no need to produce the stamper 5′ again from the beginning. By modifying the inner surface shape of the cavity 7 of the reception piece 6, the shape of the stamper 5′ can be repeatedly modified in a short time. As a result, the manufacturing cost of the stamper 5′ can be cut.

It is to be noted that, at the time of modifying the stamper 5′ as described above, the stamper 5′ is set to the lens mold 60 shown in FIG. 12, and the shape of the stamper 5′ may be modified in the process of manufacturing a molding as a product.

(Stamper Manufacturing Method 2)

(Manufacturing Method of Stamper for Concave Lens)

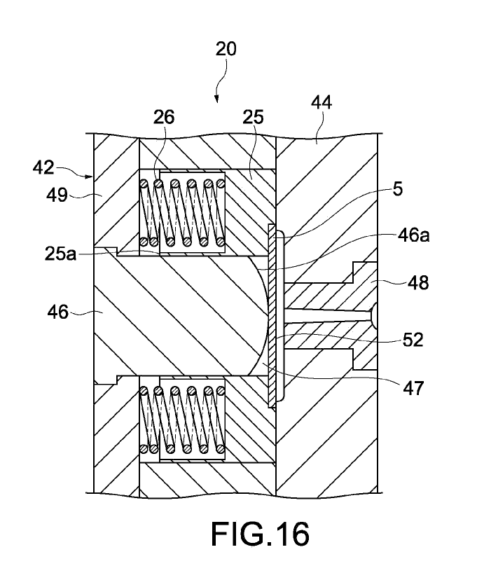

FIG. 16 is a cross-sectional view schematically showing a stamper die for manufacturing a stamper 5″ used for forming a concave lens as a molding, with the straight plate member 5 as a mold target being set. It should be noted that, on one surface of the straight plate member 5, the moth-eye structure 51 has already been formed on the master 1a.

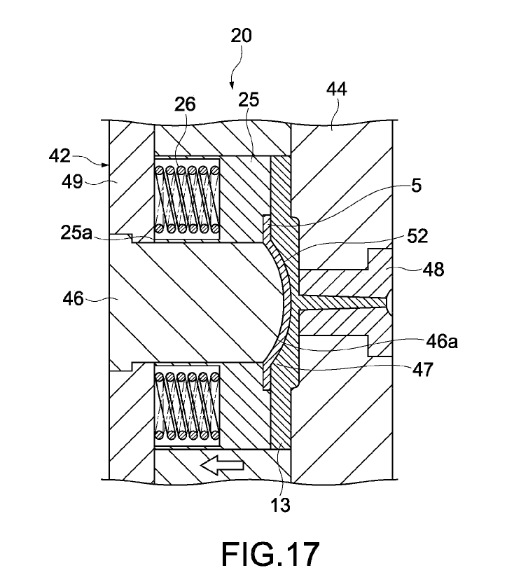

A stamper die 20 is provided with a movable plate 42 and a fixed plate 44. The movable plate 42 is provided with a reception piece 46, and the fixed plate 44 is provided with a sprue bush 48. The sprue bush 48 may be the same as the sprue bush 8 shown in FIGS. 4 and 5, or may be a sprue bush without the diffusion area 8d. The plate member 5 is set so that the formation surface 52 of the moth-eye structure 51 (FIG. 1F) is directed to the side of the fixed plate 44. The reception piece 46 has an end surface 46a that is a spherical surface having a curvature R1, for example. The end surface 46a corresponds to an inner surface of a cavity 47 along which the plate member 5 is formed. The reception piece 46 is mounted and fixed on a base plate 49 fixed to the movable plate 42. To the base plate 49, an elastic member 26 such as a coil spring is provided. A ring-shaped reception member 25 is elastically supported by the base plate 49 through the elastic member 26 and provided to slide around the reception piece 46. A plurality of coil spring as the elastic members 26 are provided shown in FIG. 17, but only one coil spring in which the reception piece 46 is inserted may be used.

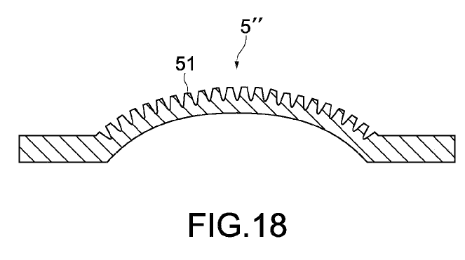

FIG. 17 is a cross-sectional view showing the stamper die 20 structured as described above in a state where the resin 13 as the continuous body is fed into the cavity 47 of the stamper die 20, and the plate member 5 is subjected to the drawing process. By the pressure of the resin 13 fed into the cavity 47 through the sprue bush 48, the reception member 25 is moved, and the plate member 5 is deformed. An end portion 25a of the reception member 25 on the side of the base plate 49 is brought into contact with the base plate 49, thereby stopping the reception member 25. In this way, the formation surface 52 of the moth-eye structure 51 of the plate member 5 is deformed into a shape in accordance with the inner surface shape of the cavity 47 by the pressure of the resin 13. As a result, as shown in FIG. 18, the stamper 5″ having the convex shape and having the moth-eye structure 51 on the convex surface is formed. In the moth-eye structure 51, each of the protrusions is directed in a direction normal to the convex surface.

By forming a mold target by using the stamper 5″ manufactured as described above, the concave lens having the plurality of protrusions in the normal directions to the concave surface can be manufactured.

The embodiment of the present invention is not limited to that described above, and other various embodiments can be conceived.

In the stampers 5′ and 5″, the pattern structure such as the moth-eye structure is formed on the spherical surface. That is, for example, in FIGS. 4 and 16, the inner surface shape of the cavities 7 and 47 is the spherical surface, and the entire shape of the formation surface 52 on which the moth-eye structure 51 of the stamper 5″ is formed is the spherical shape. However, the shape of the surface may be any shape, as long as the surface is a nonplanar surface. The nonplanar surface includes a curved surface and a surface in combination with two or more planes. The curved surface includes a spherical surface, a non-spherical surface, and the like.

In the above embodiment, as the molding to be a product, the optical device having the moth-eye structure is used, but the structure is not limited to the moth-eye structure, and an optical device having various pattern structures formed on a nonplanar surface may be used as an example. In addition, as the product, the lens is used as an example in the above embodiment, but the stamper and the manufacturing method of the stamper according to the embodiment can be applied to another optical device such as an optical sheet having a nonplanar surface.

In the above embodiments, the example in which the lens as the resin product is formed by using the stamper 5 is described, but the lens is not limited to the resin product and may be a glass product.

In addition to the optical device, in a case where a petri dish or the like for cell culture that is used in a biotechnology field or the like is manufactured, the stamper 5″ according to the above embodiment can be applied. In this case, the entire shape of the surface is a nonplanar surface, and a petri dish having a minute convex-concave structure in which cells are contained is formed with the stamper 5″. Further, as an example of the pattern structure other than the moth-eye structure, a pattern of an electric circuit may be given.

In the above embodiment, the intervals of the protrusions of the moth-eye structure are set to several hundreds nanometers that is equal to the wavelength (or half the wavelength) of visible light, for example, 200 to 300 nm. However, in a case where the pattern structure other than the moth-eye structure, such as the electric circuit, is applied, the intervals in the pattern structure may be set so that the patterns can be visually confirmed, for example, set to be 0.1 mm or more, several millimeters or more, or less than 200 to 300 nm.

As the continuous body, the resin 13 that is a solid is used, but a fluid such as a liquid and a gas may instead be used. As an example of the liquid, oil or the like may be used. As an example of the gas, air, an inert gas, or the like may be used.

In the above embodiment, the description is given on the example in which one lens is formed. However, a form in which a plurality of lens are formed at the same time like a compound eye lens may be used. In this case, by the manufacturing method described with reference to FIGS. 5 or 17, the stamper 5 having a plurality of nonplanar pattern-structure formation surfaces is manufactured.

In the above embodiment, the stamper die 10 and the lens mold 60 differ from each other, but may be the same.

The present application contains subject matter related to that disclosed in Japanese Priority Patent Application JP 2009-113284 filed in the Japan Patent Office on May 8, 2009, the entire content of which is hereby incorporated by reference.

What is claimed is:

1. A method of manufacturing a stamper, comprising:
setting a straight plate member to a die, the plate member having a formation surface on which a predetermined pattern structure is formed and an opposite surface thereof, so as to cause the opposite surface to face a cavity of the die; and
feeding a continuous body into the cavity from a side of the formation surface of the plate member and pressurizing the plate member with the continuous body, to deform an entire shape of the formation surface of the plate member set to the die into a shape corresponding to the cavity.

2. The method of manufacturing a stamper according to claim 1, further comprising:
modifying a shape of an inner surface of the cavity of the die after the plate member is pressurized;
setting a stamper formed by the pressurizing to the die having the cavity, the shape of the inner surface of which is modified; and
pressurizing, with the continuous body fed into the cavity, the stamper set to the die, to deform an entire shape of the formation surface of the stamper into a shape corresponding to the modified cavity of the die.

3. The method of manufacturing a stamper according to claim 1,
wherein the stamper is a stamper used for forming an optical device having an optical pattern structure corresponding to the pattern structure.

4. The method of manufacturing a stamper according to claim 1,
wherein the die is a direct gate type.

5. The method of manufacturing a stamper according to claim 1,
wherein the continuous body is a resin.

6. A stamper manufactured by a manufacturing method including
setting a straight plate member to a die, the plate member having a formation surface on which a predetermined pattern structure is formed and an opposite surface thereof, so as to cause the opposite surface to face a cavity of the die, and
feeding a continuous body into the cavity from a side of the formation surface of the plate member and pressurizing the plate member with the continuous body, to deform an entire shape of the formation surface of the plate member set to the die into a shape corresponding to the cavity.

7. A method of manufacturing a molding, comprising:
preparing a stamper formed by setting a straight plate member to a die, the plate member having a formation surface on which a predetermined pattern structure is formed and an opposite surface thereof, so as to cause the opposite surface to face a cavity of the die and pressurizing the plate member with a continuous body fed into the cavity of the die from a side of the opposite surface of the plate member, to deform an entire shape of the formation surface of the plate member into a shape corresponding to the cavity of the die; and
forming a mold target object having a structure corresponding to the pattern structure by using the stamper.
